(19) United States
(12) Patent Application Publication
(10) Pub. No.: US 2008/0079355 A1
(43) Pub. Date: Apr. 3, 2008

(54) Organic Electroluminescent Device

(75) Inventor: Euan C. Smith, Cambridgeshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CAMBRIDGE DISPLAY TECHNOLOGY LIMITED, Cambridgeshire (GB)

(21) Appl. No.: 11/722,754

(22) PCT Filed: Dec. 2, 2005
(86) PCT No.: PCT/GB05/04616

§ 371 Date: Oct. 16, 2007

(30) Foreign Application Priority Data
Dec. 24, 2004 (GB) 0428405.5

(51) Int. Cl. H01J 1/62; H01J 9/00

(52) U.S. Cl. 313/504; 445/24

(57) ABSTRACT

An organic electroluminescent device comprising: a substrate; a first electrode disposed over the substrate for injecting charge of a first polarity into an organic light emitting layer; a second electrode disposed over the first electrode for injecting charge of a second polarity opposite to said first polarity into an light emitting layer; an organic light emitting layer disposed between the first and the second electrodes forming a pixel array having a pixel pitch P; and an encapsulant disposed over the second electrode, wherein the second electrode is transparent to light emitted by the organic light emitting layer and an optical structure is provided in the encapsulant, said second electrode and said encapsulant being of a whereby the optical structure is a distance D from the light emitting layer, the distance D being less than half the pixel pitch P.

The present invention relates to an organic electroluminescent device and a method of manufacture thereof.

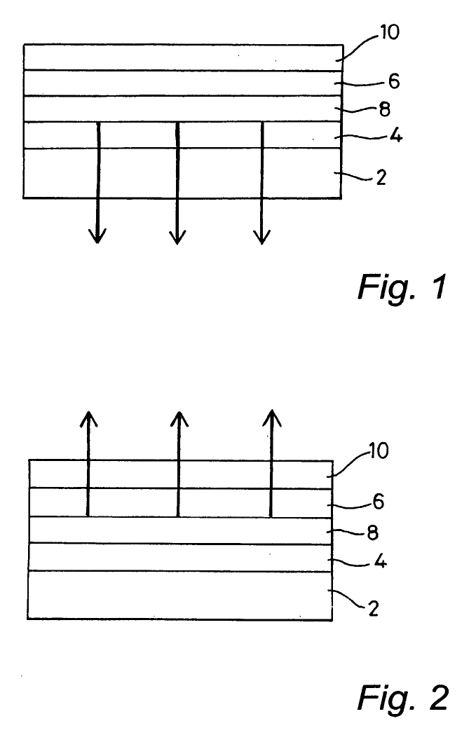

Organic electroluminescent devices are known, for example, from PCT/WO/13148 and U.S. Pat. No. 4,539,507. Such devices generally comprise: a substrate 2; a first electrode 4 disposed over the substrate 2 for injecting charge of a first polarity; a second electrode 6 disposed over the first electrode 4 for injecting charge of a second polarity opposite to said first polarity; an organic light emitting layer 8 disposed between the first and the second electrodes; and an encapsulant 10 disposed over the second electrode 6. In one arrangement shown in FIG. 1, the substrate 2 and first electrode 4 are transparent to allow light emitted by the organic light-emitting layer 8 to pass therethrough. In another arrangement shown in FIG. 2, the second electrode 6 and the encapsulant 10 are transparent so as to allow light emitted from the organic light-emitting layer 8 to pass therethrough.

Variations of the above described structures are known. The first electrode may be the anode and the second electrode may be the cathode. Alternatively, the first electrode may be the cathode and the second electrode may be the anode. Further layers may be provided between the electrodes and the organic light-emitting layer in order to aid charge injection and transport. The organic material in the light-emitting layer may comprise a small molecule, a dendrimer or a polymer and may comprise phosphorescent moieties and/or fluorescent moieties. The light-emitting layer may comprise a blend of materials including light emitting moieties, electron transport moieties and hole transport moieties. These may be provided in a single molecule or on separate molecules.

By providing an array of devices of the type described above, a display may be formed comprising a plurality of emitting pixels. The pixels may be of the same type to form a monochrome display or they may be different colours to form a multicolour display.

A problem with organic electroluminescent devices is that much of the light emitted by organic light-emitting material in the organic light-emitting layer does not escape from the device. The light may be lost within the device by scattering, internal reflection, wave guiding, absorption and the like.

One way of increasing the amount of light which escapes from the device is to provide a microlens array, each lens of the array being aligned with an emitting pixel of the organic electroluminescent device so as to aid in directing light to escape from the device.

An example of the use of microlenses in an organic electroluminescent device is disclosed in WO03/007663 in which a microlens array is provided on an opposite side of a substrate to a light emitting structure of the device.

JP 2002-216947 discloses an organic electroluminescent device comprising a microlens sheet also on an opposite side of a substrate to a light emitting structure of the device.

JP 2002-184567 discloses an organic electroluminescent device comprising a transparent substrate having a microlens structure thereon on an opposite side of the substrate to a light emitting structure of the device.

EP 1275513 discloses forming microlenses by ink jet printing. JP 2003-291406 and JP 2003-257627 disclose prefabricating a microlens film and adhering it to an organic electroluminescent device using an adhesive resin. U.S. Pat. No. 6,468,590 discloses an organic light-emitting device comprising a siloxane film encapsulant. This document also discloses that a lens may be embedded in the encapsulant film or alternatively a lens may be directly formed in the siloxane film by means of embossing.

Another way of increasing the amount of light which escapes from the device is to provide a reflective layer to reflect emitted light towards a viewing direction of the device. An example of such a reflecting layer is a retroreflector comprising, for example, a corner cube array. This optical structure functions by reflecting any light back in a direction from which it came, spacially displaced to opposite the centre of the specific corner cube it entered. If the corner cube structures are sufficiently small then the spacial displacement is negligible.

US 2002/0043931 discloses an organic electroluminescent device comprising a substrate having a retroreflector disposed thereon.

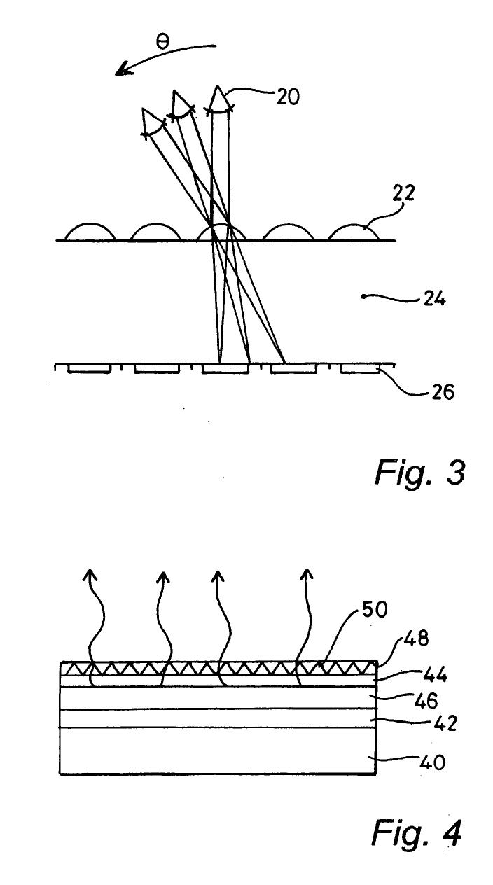

A problem with the aforementioned arrangements is that the optical structures can cause undesirable optical side effects. For example, as viewing angle changes undesirable optical effects are introduced by the presence of the optical structures resulting in, for example, variation in brightness with viewing angle. This phenomenon is illustrated in FIG. 3 which shows a display comprising a plurality of emitting pixels 26 on one side of a substrate 24 and a plurality of microlenses 22, each microlens aligned with a corresponding pixel. As the viewer 20 moves relative to the display such that the viewing angle Θ increases, the intensity of light falls as the microlenses focuses between the emitting pixels. The light intensity then increases as the microlenses focus onto a different pixel. That is, with the microlens array positioned at a distance from the emitting pixels in a direction perpendicular to the plane of the device, light emitted from a pixel can propagate in a direction parallel to the plane of the device and exit through a microlens which corresponds to a different pixel leading to optical defects in the display. These optical defects are particularly evident as the viewing angle is varied.

One aim of the present invention is to solve the problem outlined above.

According to a first aspect of the invention there is provided an organic electroluminescent device comprising: a substrate; a first electrode disposed over the substrate for injecting charge of a first polarity; a second electrode disposed over the first electrode for injecting charge of a second polarity opposite to said first polarity; an organic light emitting layer disposed between the first and the second electrode forming a pixel array having a pixel pitch P; and an encapsulant disposed over the second electrode, wherein the second electrode is transparent to light emitted by the light emitting layer and an optical structure is provided in the encapsulant, said second electrode and said encapsulant being of a thickness whereby the optical structure is a distance D from the light emitting layer, the distance D being less than half the pixel pitch P.

The pixel pitch P is the distance from the centre of one pixel to the centre of an adjacent pixel.

Preferably the distance D is less than one third the pixel pitch P. More preferably the distance D is less than one quarter the pixel pitch P. More preferably the distance D is less than one sixth the pixel pitch P. More preferably the distance D is less than one eight the pixel pitch P. In some applications the distance D may be less than one tenth the pixel pitch P. The specific ratio of distance D to pixel pitch P will be dependent on the type of display which is required. For example, for some displays only a narrow viewing angle is required and accordingly a ratio of D:P in the upper part of the claimed range may be selected, i.e. distance D approaching one half the pixel pitch. Furthermore, low contrast displays may be provided with distance D approaching one half the pixel pitch. For wide viewing angle displays and/or high contrast displays then distance D may be made much less than half the pixel pitch P.

The present inventor has found that the above-described optical side effects are dependent on both the pixel pitch of the emitting pixel array and the distance of the optical structure from the emitting array. That is, it is the ratio P:D that is important. By providing the optical structure close to the emitting pixel array relative to the pixel pitch of the pixel array optical side effects are minimized while still increasing light output from a device.

Generally, the present inventor has found that it is advantageous to provide the optical structure close to the emitting pixel array. The present inventor has found that it is possible to provide an optical structure less than 50 microns from the emitting pixel array. Indeed, the present inventor has found that it is possible to provide an optical structure less 10 microns, less than 1 micron and even less than 100 nm from the emitting pixel array. However, it has been found that a little blurring between pixels can be advantageous in some applications so as to prevent the edges of each pixel becoming visible. Accordingly, it may be preferable for the distance D to be greater than one hundredth the pixel pitch, greater than one fiftieth the pixel pitch, greater than one twentieth the pixel pitch, and even greater than one tenth the pixel pitch in some applications. Accordingly, by combining the upper limits for the ratio of P:D as mentioned previously with these lower limits, a preferred range can be arrived at depending on the type of display (high or low contrast; wide or narrow viewing angle) to be produced.

For a very large pixel pitch, such as 1 mm in a large screen display, the optical structure can be placed a relatively large distance from the pixel array without incurring optical side effects of sufficient magnitude to be problematic. However, for a smaller pixel pitch, such as 100 microns, the optical structure must be placed closer to the pixel array, i.e. less than 50 microns, to avoid incurring optical side effects of sufficient magnitude to be problematic.

In one arrangement the substrate, the first electrode and the second electrode are transparent to light emitted by the organic light emitting layer. This arrangement, combined with a transparent encapsulant results in a fully transparent device architecture.

Preferably the first electrode is an anode and the second electrode is a cathode.

The cathode may comprises a layer of barium with a layer of aluminium thereover. Each of these layers is preferably less than 10 nm thick and more preferably each layer is approximately 5 nm thick. This arrangement provides a cathode with good electrical properties while also being transparent. Furthermore, the cathode does not adversely react with other components in the device. An alternative cathode utilizes a layer of barium with a layer of silver thereover. Each of these layers is preferably less than 10 nm thick and more preferably each layer is approximately 5 nm thick. This cathode is more transparent than the aforementioned Barium/Aluminium arrangement.

The encapsulant may comprise an alternating stack of polymer and dielectric layers. This has been shown to provide a good barrier against ingress of moisture and oxygen.

The encapsulant may comprise an inner portion (on the same side as the emitting layer) and an outer portion (on an opposite side to the emitting layer), with the inner portion comprising one or more layers of an inorganic material and the outer portion comprising a layer having the optical structure therein. Various inorganic materials may be used for the inner portion. Metal oxides are one preferred example. In particular, a high refractive index dielectric layer forming an index-matching layer may be used to enhance optical transmission. The outer portion is preferably made of a lacquer material. This lacquer material is preferably UV curable. The outer portion is preferably made of a material which is mouldable. The inner portion may comprise an alternating stack of polymer and dielectric layers as described previously.

The above-described encapsulant structure provides an inner portion which prevents ingress of moisture and oxygen and an outer layer which is suitable for providing an optical structure therein. The outer layer will also aid in preventing ingress of moisture and oxygen and gives physical strength to the encapsulant. The inner layer may be index-matched for improving light output. The thickness of the inner portion may be dependent on the pixel pitch. However, it will be generally thin (e.g. less than 10 microns, more preferably less than 5 microns) for good transmission. The lacquer may be hundreds of microns thick with the optical structure being provided to a suitable depth according to the pixel pitch of the emitting array.

The optical structure may be one of a corrugated surface, a diffractive structure, a microlens array, a prismatic array, an array of Fresnel lenses, and a retroreflector. Optionally, the optical structure is embedded in the encapsulant. The optical structure may have a roughened surface to further increase light output from the device.

A charge transport layer may be provided between the second electrode and the light emitting layer, the charge transport layer being of a thickness whereby the optical structure is still close to the light emitting layer relative to the pixel pitch as discussed above. It is known that charge transport layers can improve device performance. However, in accordance with embodiments of the present invention the thickness of the layer may be optimised so that the optical structure is positioned for best display results. As discussed previously, the thickness of the layer will depend on the pixel pitch of the emitting array.

The present inventor has found that the undesirable optical side effects occurring with the prior art arrangements are a result of the optical structures being spaced apart from the light-emitting layer relative to the pixel pitch of the emitting array. Embodiments of the present invention solve this problem by provide an optical structure which is positioned in close proximity to the light emitting layer of the device. By providing the optical structure in close proximity with the light emitting layer, any scattering, internal reflection, absorption and the like between the light emitting layer and the optical structure is minimized. This results in an increase in the percentage of light escaping from the device. Furthermore, the undesirable optical effects occurring in prior art arrangements are avoided.

According to a second aspect of the present invention there is provided a method of manufacturing an organic electroluminescent device comprising the steps: depositing a first electrode over a substrate for injecting a charge of a first polarity; depositing an organic light emitting layer over the first electrode forming a pixel array having a pixel pitch P; depositing a second electrode over the organic light emitting layer for injecting charge of a second polarity opposite to said first polarity; depositing an encapsulant over the second electrode; and providing an optical structure in the encapsulant, wherein the second electrode is transparent to light emitted by the light emitting layer and the second electrode and the encapsulant are deposited to have a thickness whereby the optical structure is a distance D from the light emitting layer, the distance D being less than half the pixel pitch P.

Preferably the optical structure is provided by embossing, printing or etching.

If the optical structure is embossed, the encapsulant may be softened by heating or the application of a solvent after deposition for embossing the optical structure therein. Alternatively, the encapsulant may be deposited and an embossing mould applied prior to curing of the encapsulant.

In one preferred method an embossing mould transparent to UV light is used for the embossing step and the encapsulant is cured by exposure to UV light passing through the embossing mould when applied to the encapsulant.

Embodiments of the present invention will now be described by way of example only with reference to the accompanying drawings, in which:

FIG. 1 shows a known structure of an organic light emitting device;

FIG. 2 shows a known structure of an organic light emitting device;

FIG. 3 illustrates a problem with known optical arrangements in organic light emitting devices;

FIG. 4 shows an organic light emitting device according to an embodiment of the present invention;

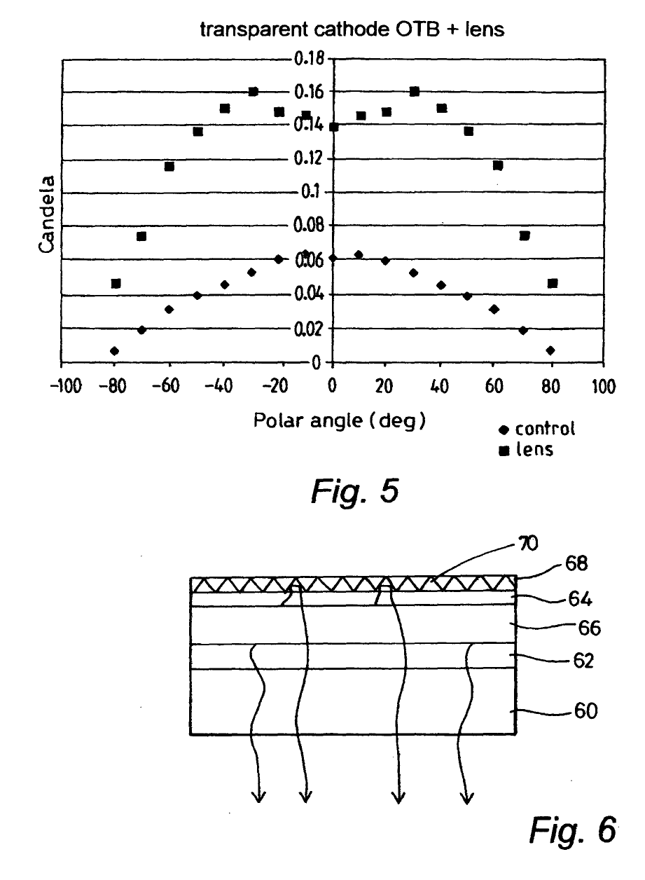

FIG. 5 shows modelling results for an organic light emitting device according to an embodiment of the present invention compared with a known organic light emitting device; and

FIG. 6 shows an organic light emitting device according to another embodiment of the present invention.

Embodiments of the present invention will now be described in more detail.

FIG. 4 shows an embodiment of the present invention comprising: a substrate 40; a first electrode 42 disposed over the substrate 40 for injecting charge of a first polarity; a second electrode 44 disposed over the first electrode 42 for injecting charge of a second polarity opposite to the first polarity; an organic light emitting layer 46 forming a pixel array having a pixel pitch P disposed between the first and the second electrode; and a thin film encapsulant 48 disposed over the second electrode 44, wherein the second electrode 44 is transparent to light emitted by the light emitting layer 46 and an optical structure 50 is provided in the thin film encapsulant 48, the second electrode 44 and the thin film encapsulant 48 being of a thickness whereby the optical structure 50 is a distance D from the light emitting layer 46, the distance D being less than half the pixel pitch P.

In the embodiment illustrated in FIG. 4, the optical structure 50 is a microlens array. Each microlens is positioned over a corresponding pixel of the light emitting layer of the device.

The first electrode 42 is preferably an anode. The anode may be made of ITO. The second electrode 44 is preferably a cathode. The cathode is selected from materials that have a workfunction allowing injection of electrons into the electroluminescent layer. Other factors influence the selection of the cathode such as the possibility of adverse interactions between the cathode and the electroluminescent material. Various cathode structures are known which consist of a single material such as a layer of aluminium, or alternatively comprise a plurality of metals, for example a bilayer of calcium and aluminium as disclosed in WO 98/10621, elemental barium disclosed in WO 98/57381, Appl. Phys. Lett. 2002, 81(4), 634 and WO 02/84759 or a thin layer of dielectric material to assist electron injection, for example lithium fluoride disclosed in WO 00/48258 or barium fluoride, disclosed in Appl. Phys. Lett. 2001, 79(5), 2001. In order to provide efficient injection of electrons into the device, the cathode preferably has a workfunction of less than 3.5 eV, more preferably less than 3.2 eV, most preferably less than 3 eV.

In this embodiment of the present invention, it is a requirement that the cathode should be transparent. One preferred transparent cathode utilizes a layer of Barium and a layer of silver thereover each layer being of a thickness of approximately 5 nm.

Optical devices tend to be sensitive to moisture and oxygen. Accordingly, the substrate preferably has good barrier properties for prevention of ingress of moisture and oxygen into the device. The substrate is commonly glass, however alternative substrates may be used, in particular where flexibility of the device is desirable. For example, the substrate may comprise a plastic as in U.S. Pat. No. 6,268,695 which discloses a substrate of alternating plastic and barrier layers or a laminate of thin glass and plastic as disclosed in EP 0949850.

The device is encapsulated with an encapsulant to prevent ingress of moisture and oxygen. Suitable encapsulants include films having suitable barrier properties such as alternating stacks of polymer and dielectric as disclosed in, for example, WO 01/81649. A getter material for absorption of any atmospheric moisture and/or oxygen that may permeate through the substrate or encapsulant may be disposed between the substrate and the encapsulant.

The electrode layers, organic light emitting layer, and thin film encapsulant may be deposited by vapour deposition or may be solution processed by, for example, spin coating or inkjet deposition.

By providing a very thin second electrode and a very thin encapsulant, the optical structure provided in the encapsulant is provided within a distance D from the light emitting layer 46, the distance D being less than half the pixel pitch P.

FIG. 5 shows a graph illustrating modelling results for an organic light emitting device comprising a microlens structure as illustrated in FIG. 4 compared with an equivalent device which does not comprise a microlens structure. The pixel pitch is 0.3 mm and the radius of curvature is 0.3 mm. Two million light rays were traced.

A large increase in light output from the device is shown even at large viewing angles. Furthermore, periodic decreases in light intensity with increasing viewing angle are not observed as with prior art arrangements in which the microlenses are disposed further from the light emitting layer.

An alternative arrangement is illustrated in FIG. 6 which comprises: a substrate 60; a first electrode 62 disposed over the substrate 60 for injecting charge of a first polarity; a second electrode 64 disposed over the first electrode 62 for injecting charge of a second polarity opposite to the first polarity; an organic light emitting layer 66 forming a pixel array having a pixel pitch P disposed between the first and the second electrode; and a thin film encapsulant 68 disposed over the second electrode 64, wherein the substrate 60, the first electrode 62 and the second electrode 64 are transparent to light emitted by the light emitting layer 66 and a retroreflector 70 is provided in the thin film encapsulant 68, the second electrode 64 and the thin film encapsulant 68 being of a thickness whereby the retroreflector 70 is a distance D from the light emitting layer 66, the distance D being less than half the pixel pitch P.

The retroreflector produces a contrast enhancing display with minimal loss of light output through the use of a transparent device architecture (i.e. a transparent substrate and electrodes) and a retroreflecting back layer.

Contrast is poor for standard devices, whether top or bottom emitting, as the opaque electrode is reflecting. Use of a circular polariser removes the reflection at a cost of 55 to 60% less light emission. Black layers may be provided on an electrode but at a cost of 50 to 55% of the light emission.

The embodiment illustrated in FIG. 6 utilises a fully transparent device architecture and an optical structure patterned with corner cubes, otherwise known as a retroreflector. The optical structure functions by reflecting any light back in a direction from which it came, spacially displaced to opposite the centre of the specific corner cube it entered. If the corner cube structures are sufficiently small then the spacial displacement is negligable.

Light emitted by the display will propagate in two directions, both towards the viewer and towards the back. Light incident on the back layer will retroreflect back through the pixel from which it originated and then pass through to the viewer essentially as if it had been emitted in that direction in the first place. Light loses will be a combination of the reflectivity of the corner cube (approximately 10% loss) and absorption within the device. If, as the worst case, the light emitted from either side of the light emitting layer is equal (usually it is unbalanced and one would direct the greater brightness directly towards the viewer) this will result in only a 30% reduction in optical output, or half the total loss from a circular polariser.

The corner cube sheet improves contrast due to its retroreflecting nature. By placing the retroreflector close to the emitting layer then absorption and scattering between the retroreflector and the emitting pixels which could lead to undesirable optical side effects is minimised.

Embodiments of the present invention provide a device in which an additional adhesive layer between the optical structure and the second electrode is not required. A resin is deposited, moulded and cured such that the resin encapsulates the cathode and forms the optical structure without an additional layer between the resin and the cathode. Problems with deflects (both optical and physical) at an interface between a resin and a prefabricated microlens film in prior art arrangements are avoided. No prefabricating steps are required for the optical structure and curing of the encapsulant and formation of the optical structure can be carried out in a single step.

The present inventor has found that it is possible to form an optical structure in this manner within an extremely thin film encapsulant. This, coupled with the use of an extremely thin transparent cathode results in the optical structure being provided in close proximity to the emitting layer.

A further problem with some of the prior art arrangements which comprise a prefabricated film is that it is difficult to ensure accurate alignment of the optical structures in the film over the pixels when the film is attached as a sheet due to a combination of stretching/distortion of the sheet and differential thermal expansion between the glass substrate and plastic film. In contrast, embossing with a glass mould according to an embodiment of the present invention ensures stability and thermal matching and can be used to produce extremely accurately aligned features.

The optical structures can be formed by temporarily softening the encapsulant (commonly using heat or a solvent) and then embossing the thin film encapsulant with a master mould. Alternatively, the optical structures can be embossed in the thin film encapsulant prior to curing of the encapsulant. In a particularly preferred embodiment, a UV curable lacquer is used for the thin film encapsulant and during the final cure of the encapsulant, a transparent mould (e.g. glass) is applied to emboss the lacquer which is then cured by UV exposure through the transparent mould (applying heat if required).

The present inventor has found that it is possible to emboss an optical structure into an extremely thin encapsulant provided over a thin transparent cathode. Preferably the thin film encapsulant is a UV-curable lacquer which is mouldable such as an acrylate. The thin film encapsulant may be embossed using solvent wetting embossing. The optical structure may be any non-planar structure including a corrugated surface, a diffractive structure, a prismatic array, an array of Fresnel lenses, a retroreflector and the like. The particular optical structure may be selected according to the particular use of the device. For example, for wide viewing angles a low curvature optical structure may be provided while for narrow viewing angles a higher curvature optical structure may be provided.

In order to ensure a clean release of the embossing mould/stamp during the embossing step a release layer may be provided. An example of such a layer is a fluorinated layer such as CF₄ plasma.

While this invention has been particularly shown and described with reference to preferred embodiments thereof, it will be understood by those skilled in the art that various changes in form and details may be made therein without departing from the scope of the invention as defined by the appended claims.

1. An organic electroluminescent device comprising:
a substrate;
a first electrode disposed over the substrate for injecting charge of a first polarity into an organic light emitting layer;
a second electrode disposed over the first electrode for injecting charge of a second polarity opposite to said first polarity into an organic light emitting layer;
an organic light emitting layer disposed between the first and the second electrodes forming a pixel array having a pixel pitch P; and
an encapsulant disposed over the second electrode, wherein the second electrode is transparent to light emitted by the organic light emitting layer and an optical structure is provided in the encapsulant, said second electrode and said encapsulant being of a thickness whereby the optical structure is a distance D from the light emitting layer, the distance D being less than half the pixel pitch P.

2. An organic light emitting device according to claim 1, wherein the substrate, the first electrode and the second electrode are transparent to light emitted by the organic light emitting layer.

3. An organic light emitting device according to claims 1, wherein the first electrode is an anode and the second electrode is a cathode.

4. An organic light emitting device according to claim 3, wherein the cathode comprises a layer of barium and a layer of silver thereover.

5. An organic light emitting device according to claim 4, wherein each of the barium and silver layers is less than 10 nm in thickness.

6. An organic light emitting device according to claim 1, wherein the encapsulant comprises an inner portion comprising one or more layers of an inorganic material and an outer portion having the optical structure therein.

7. An organic light emitting device according to claim 6, wherein the outer portion is a layer of a lacquer material.

8. An organic light emitting device according to claim 7, wherein the lacquer material is UV curable.

9. An organic light emitting device according to claim 6, wherein the outer portion is made of a material which is moldable.

10. An organic light emitting device according to claim 1, wherein the optical structure is one of a corrugated surface, a diffractive structure, a microlens array, a prismatic array, an array of Fresnel lenses, and a retroreflector; and optionally wherein the optical structure is embedded in the encapsulant.

11. An organic electroluminescent device according to claim 1, wherein a charge transport layer is provided between the second electrode and the light emitting layer, said charge transport layer being of a thickness whereby the optical structure is a distance D from the light emitting layer, the distance D being less than half the pixel pitch P.

12. A method of manufacturing an organic electroluminescent device comprising the steps of:
depositing a first electrode over a substrate for injecting charge of a first polarity into an organic light emitting layer;
depositing an organic light emitting layer over the first electrode forming a pixel array having a pixel pitch P;
depositing a second electrode over the organic light emitting layer for injecting charge of a second polarity opposite to said first polarity into the organic light emitting layer;
depositing an encapsulant over the second electrode; and
providing an optical structure in the encapsulant, wherein the second electrode is transparent and wherein the second electrode and the encapsulant are deposited to a thickness whereby the optical structure is a distance D from the light emitting layer, the distance D being less than half the pixel pitch P.

13. A method of manufacturing an organic electroluminescent device according to claim 12, comprising providing the optical structure by embossing, printing, or etching.

14. A method of manufacturing an organic electroluminescent device according to claim 13, comprising softening the encapsulant by heating or by applying a solvent after deposition for embossing the optical structure therein.

15. A method of manufacturing an organic electroluminescent device according to claim 13, comprising depositing the encapsulant and applying an embossing mold prior to curing the encapsulant.

16. A method of manufacturing an organic electroluminescent device according to claim 13, comprising using an embossing mold transparent to UV light for the embossing step and curing the encapsulant by exposure to UV light passing through the embossing mold when applied to the encapsulant.
